(19) United States
(12) Patent Application Publication
(10) Pub. No.: US 2022/0350770 A1
(43) Pub. Date: Nov. 3, 2022

(54) HOT-DESKING STATION AND SYSTEM

(71) Applicant: Crestron Electronics, Inc., Rockleigh, NJ (US)

(72) Inventors: Robert Bach, Lakewood Ranch, FL (US); Mark Slivosky, West Caldwell, NJ (US); William Braaf, Plano, TX (US)

(73) Assignee: Crestron Electronics, Inc., Rockleigh, NJ (US)

(21) Appl. No.: 17/734,692

(22) Filed: May 2, 2022

Related U.S. Application Data
(60) Provisional application No. 63/182,466, filed on Apr. 30, 2021.

(51) Int. Cl. G06F 13/40; G06K 7/14

(52) U.S. Cl. CPC G06F 13/4081; G06K 7/1417

(57) ABSTRACT

A method for personalizing operation of a building control system of a workspace management system including a user communication device, a hot-desking station, a workstation phone having a first graphical display device. The workstation phone may be communicatively coupled to a workspace management server, the method including receiving, over a communication network, from the workspace management server a first message including an identification of the workspace to be displayed as a QR code on the first graphical display device of the workstation phone. The user communication device may include a camera having a first interface for a first communication channel.

### CROSS-REFERENCE TO RELATED APPLICATIONS

This application claims the benefit of the filing date of U.S. Provisional Patent Application No. 63/182,466, filed Apr. 30, 2021, the disclosure of which is incorporated herein by reference.

### BACKGROUND OF THE INVENTION

### Technical Field

The present invention relates to the automatic configuration of hardware devices in a workspace and more specifically, a system for identifying and authenticating users of a shared workspace for selectively applying a predetermined hardware configuration profile.

### Background

Traditionally, organizations have focused on hot-desking or hoteling, in which workers do not have their own desk and are only given a desk when they need it (for a limited time only) as a way of saving office space to reduce real estate costs.

To accommodate this by their work organization may desire to provide workspaces in corporate offices to be booked for temporary periods of time by its visiting employees (also known as “hoteling” employees.)

One solution has been to install dedicated touch panels which provide and control a conference room to provide availability and resources centralized via local network access to a central scheduling server. For example, a touch panel located directly outside a conference room entrance may provide conference attendees local access to a network server running room scheduling software. However, to book the workspace, interaction with a highly touched surface is required while the user enters a login name, a password, and during the subsequent configuring of the workspace. Using the touch screen to authenticate, specify scheduling, and complete check-in is not particularly convenient because most users prefer not to interact directly with high-traffic, commonly touched touch screen surface.

It is therefore desirable to provide hoteling employees a way to book, check-in, and configure a workspace that is equipped with varying resources in a quick and touchless manner.

There may be instances where it is impractical to install touch panels outside each workspace. Therefore, it is further desirable to provide a more convenient way for booking an appropriate room having the appropriate resources, configured in a specific way, for a specific duration of

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DISCLOSURE OF INVENTION

In accordance with one aspect, a method for personalizing operation of a building control system of a workspace management system having: a user communication device; a hot-desking station; and a workstation phone having a first graphical display device, wherein said workstation phone is communicatively coupled to a workspace management server, comprises receiving, over a communication network, from the workspace management server a first message comprising an identification of the workspace to be displayed as a QR code on said first graphical display device of said workstation phone, wherein the user communication device comprises a camera having a first interface for a first communication channel; and a second interface for a second communication channel, the first message being received by the first interface and after receiving the first message, transmitting, by the user communication device via the second interface, a second message comprising an identity associated with the communication device; an identification of the workspace; a predetermined personalization setting; and a request to personalize said workspace, according to the predetermined personalization settings, the request comprising: instructions to provide access to said building control system and a second graphical display that is physically separate from the workstation phone and is not in direct communication with the communication device.

According to a further aspect, a method for personalizing operation of a hot-desking station communicatively coupled to a second graphical display device in a workspace comprises receiving, by a workstation phone via a user interface, a command to initiate personalization of the workstation phone; in response to receiving the command to initiate personalization, generating and transmitting, by the workstation phone, to a user communication device, a first message including an identification of the workspace, wherein the workstation phone comprises a first interface including an interface to a near field communications channel configured to operate without prior association between the user communication device and the computer system for a first communication channel and a second interface for a second communication channel, the first message being transmitted by the first interface; after transmitting the first message, receiving by the workstation phone via the second interface, a second message comprising: predetermined personalization information related to personalizing the workstation phone, wherein a portion of the predetermined personalization information is associated with an identity of the user communication device; and personalizing, by the workstation phone, its operation based on the predetermined personalization information by modifying a graphical user interface presented the said second graphical display device to provide access to a building control system, wherein the second graphical display device is physically separate from the workstation phone and is not in direct communication with the user communication device.

According to another aspect, A method for personalizing operation of a hot-desking station in a workspace comprises a user computing device communicatively coupled to a graphical display device, the method comprising: receiving, by a user communication device, from the workspace management server a first message including displayed QR code as an identification of the workspace, wherein the user communication device comprises an imaging sensor including a first interface for a short range communication channel and a second interface for a network communication channel, the first message being received by the first interface; after receiving the first message, transmitting, by the user communication device via the second interface the workspace management server, a second message comprising: an identity associated with the communication device; and the identification of the workspace; receiving, by the user communication device, from the workspace management server, predetermined personalization information related to personalizing the operation of the hot-desking station, wherein the predetermined personalization information is based, at least in part, on the identity associated with the user communication device and the identification of the workspace; and based on the predetermined personalization information, transmitting, by the user communication device, personalization settings relating to personalizing the operation of the hot-desking station, wherein the personalization settings include instructions to modify a graphical user interface presented by the graphical display device and provide access to a building control system, wherein the graphical display device is physically separate from the computer system and is not in direct communication with the communication device.

According to a further aspect a workspace management system for personalizing devices located at a hot-desking station comprises a workstation phone communicatively coupled to a building control system, the workstation phone comprising: a first interface for a first communication channel and a second interface for a second communication channel; a first memory device, storing first executable instructions; and a first processor in communication with the first memory device; a user communication device, the user communication device comprising: a third interface for the first communication channel and a fourth interface for the second communication channel; a second memory device, storing second executable instructions; and a second processor in communication with the second memory device; wherein the second processor, when executing the second executable instructions: receives, from the workstation phone, a first message, via the third interface, comprising an identification of the workspace; and after receiving the first message, transmits, a second message to a workspace management server, via the fourth interface, the second message comprising: an identity associated with the communication device; the identification of the workspace; and a request to personalize according to predetermined personalization information, the operation of devices located at the hot-desking station; and wherein the first processor, when executing the first executable instructions: receives, via the second interface, personalization instructions to personalize the operation of the building control system based on the predetermined personalization information; and personalizes the operation of any devices controlled by the building control system based on the predetermined personalization information.

According to another aspect a workspace management system comprises a building control system having a plurality of electronic devices within a workspace; a workspace management server comprising: data storage; and a sixth communication interface configured to communication with a communication network; a calendar server; a user communication device comprising: a camera configured to capture a QR Code; and a first communication interface configured to transmit an unencrypted identification of the workspace represented by the QR Code, a request to personalize a workspace according to a predetermined personalization setting, and a request a network encryption key; and a second communication interface that is configured to be unlocked by said network encryption key, the second communication interface configured to further communicate predetermined personalization information with said building control system after receipt of said network encryption key; and a hot-desking station comprising: a wired power charging port and a wireless power charger having a charging area; a display screen positioned over and centered within said charging area for displaying said QR Code; a third communication interface for communication with said workspace management server and building control system; a fourth communication interface for unencrypted communication with said user communication device; a fifth communication interface for encrypted communication with said user communication device; and a status bar for status indication.

### BRIEF DESCRIPTION OF THE DRAWINGS

The above and other objects and features of the embodiments will become apparent and more readily appreciated from the following description of the embodiments with reference to the following figures. Different aspects of the embodiments are illustrated in reference figures of the drawings. It is intended that the embodiments and figures disclosed herein are to be considered to be illustrative rather than limiting.

The components in the drawings are not necessarily drawn to scale, emphasis instead being placed upon clearly illustrating the principles of the aspects of the embodiments. In the drawings, like reference numerals designate corresponding parts throughout the several views.

### BRIEF DESCRIPTION OF THE SEVERAL VIEWS OF THE DRAWING

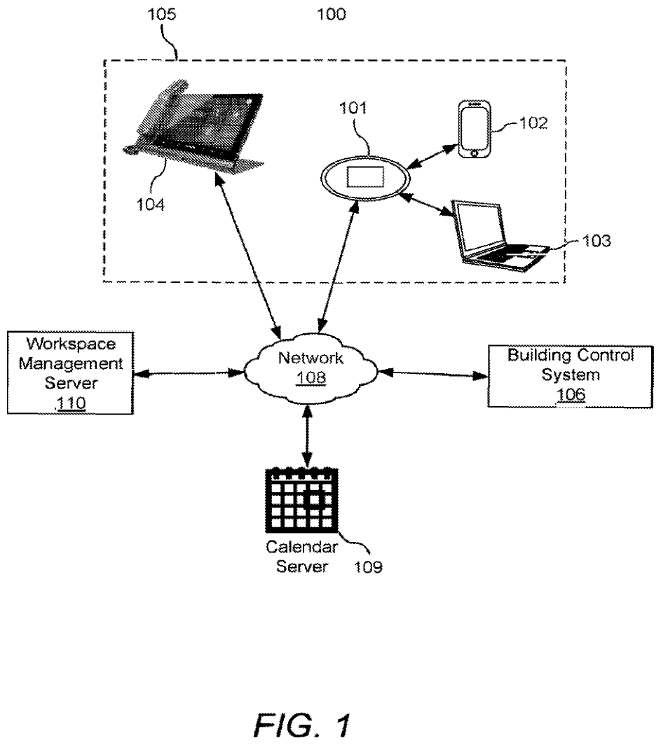

FIG. 1 illustrates a network connection diagram depicting a hot-desking management system according to an embodiment.

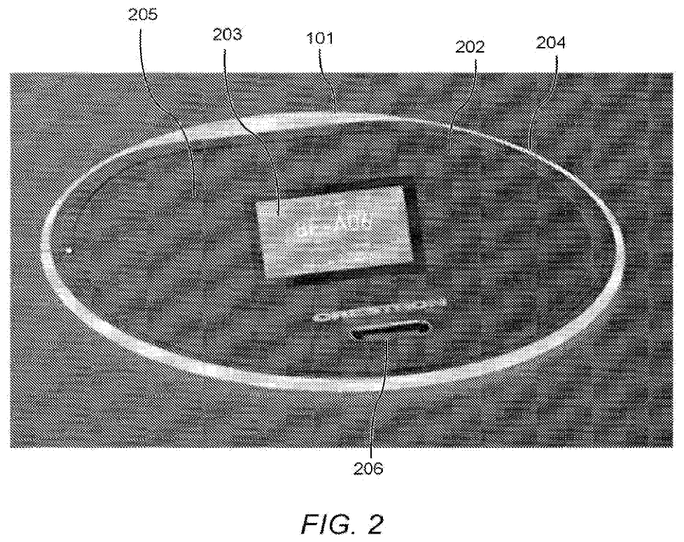

FIG. 2 illustrates a perspective view of a hot-desking station according to an embodiment.

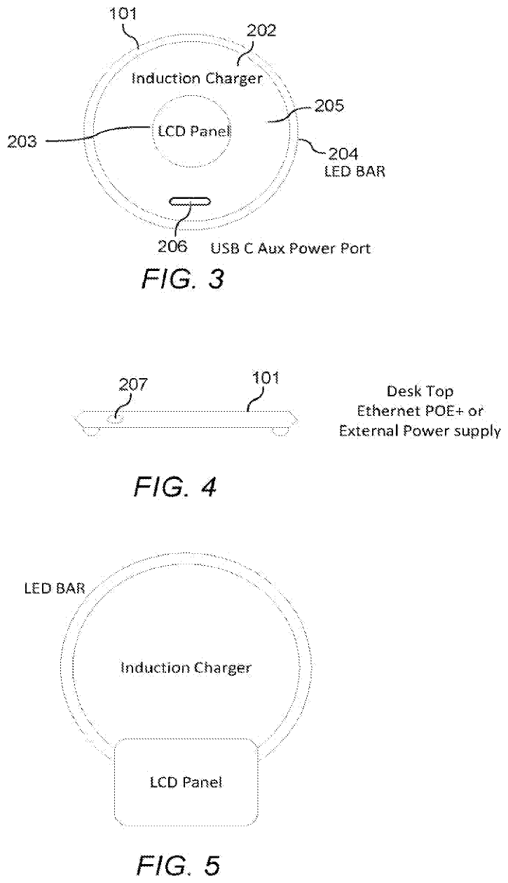

FIG. 3 illustrates a top view of the hot-desking station according to an embodiment.

FIG. 4 illustrates a front view of the hot-desking station according to an embodiment.

FIG. 5 illustrates a top view of a hot-desking station according to another embodiment.

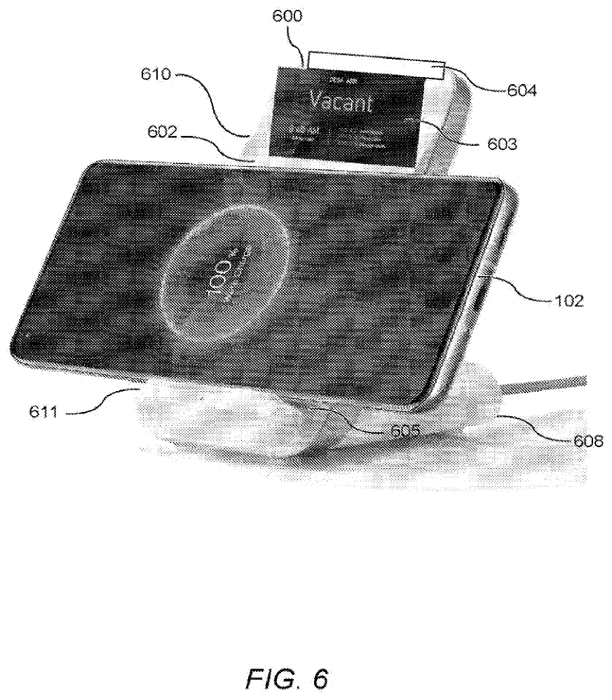

FIG. 6 illustrates a perspective view of a hot-desking station according to yet another embodiment.

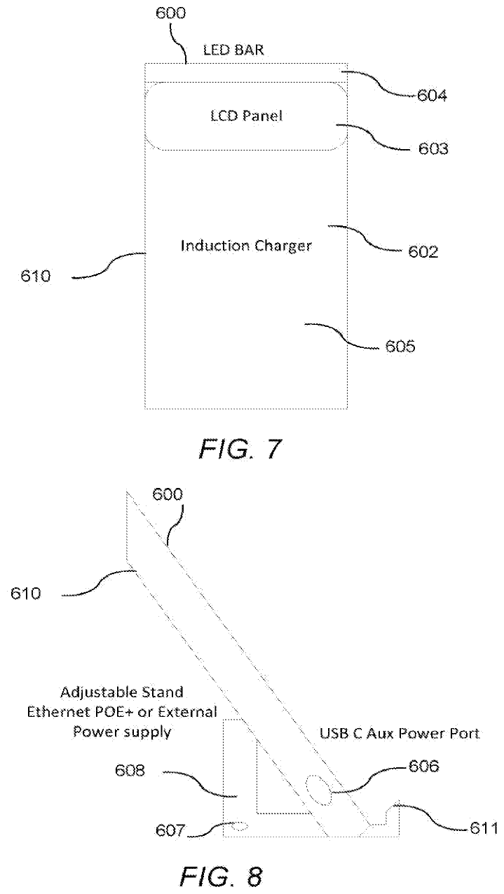

FIG. 7 illustrates a front view of the hot-desking station according to another embodiment.

FIG. 8 illustrates a side view of the hot-desking station according to another embodiment.

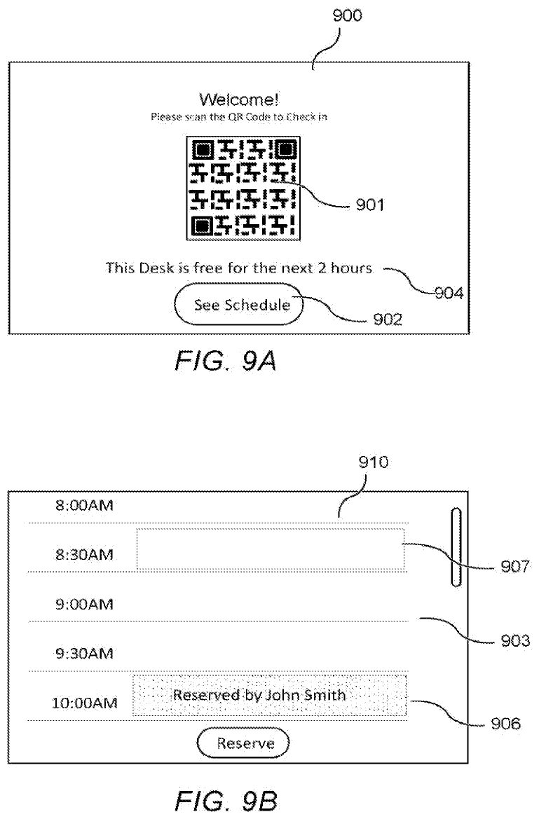

FIG. 9A illustrates a graphic user interface according to an embodiment.

FIG. 9B illustrates another screen of the graphic user interface according to an embodiment.

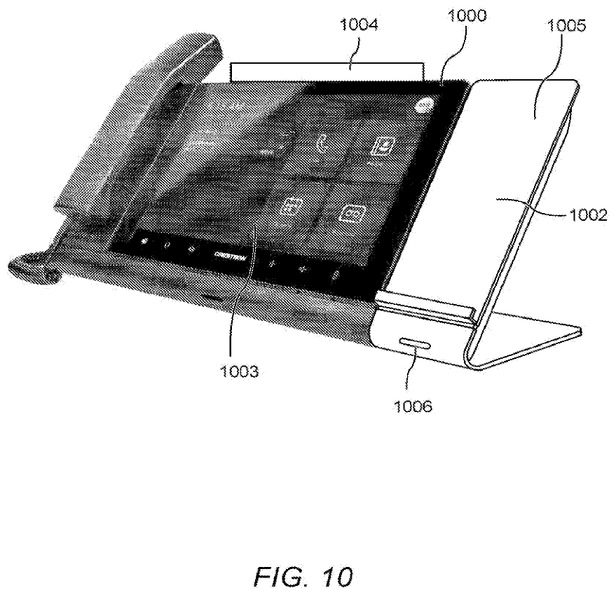

FIG. 10 illustrates a hot-desking station integrated with a phone according to an embodiment.

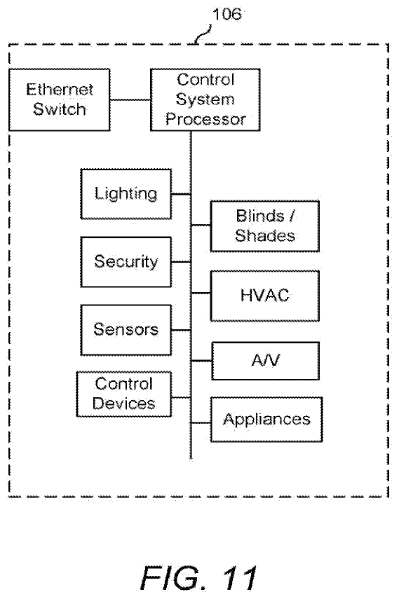

FIG. 11 illustrates a logical block diagram of a building control system.

### DETAILED DESCRIPTION OF THE INVENTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims. The detailed description that follows is written from the point of view of a control systems company, so it is to be understood that generally the concepts discussed herein are applicable to various subsystems and not limited to only a particular controlled device or class of devices, such as presentation streaming products.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” on “in an embodiment” in various places throughout the specification is not necessarily referring to the same embodiment. Further, the particular feature, structures, or characteristics may be combined in any suitable manner in one or more embodiments.

### LIST OF REFERENCE NUMBERS FOR THE MAJOR ELEMENTS IN THE DRAWING

The following is a list of major elements in the drawings in numerical order.
100 workspace management system
101 hot-desking station
102 user communication device
103 portable computer
104 workstation phone
105 workspaces
106 building control system
109 calendar server
110 workspace management server
202 wireless power charger
203 display screen
204 status bar
205 charging area
206 charging port
207 power port
214 heating and air conditioning (HVAC) devices
600 hot-desking station
602 wireless power charger
604 status bar
608 upright station body
610 rectangular upright station body
611 Hot-desking station
902 “See Schedule” button
904 status indicator
910 graphic user interface
1000 phone
1003 display screen
1006 Wired power charging port

### MODE(S) FOR CARRYING OUT THE INVENTION

The different aspects of the embodiments described herein pertain to the context of a workspace management system, and more specifically to systems, methods, and modes for providing hot-desking in a hot-desking station in a workspace management system but is not limited thereto. The embodiments of the workspace management system can be used in small, mid, or large-scale commercial spaces. While the embodiments are described herein as being implemented for commercial facilities, they are not limited to such an implementation. Products for other markets can be built upon the same framework with minimal modification. The present embodiments may be employed in other type of venues or facilities, including in residential, commercial spaces, retail, or nonprofit structures or venues. The system is further designed to be quickly deployable, allowing temporary installations for short-term to be feasible.

FIG. 1 illustrates a block diagram depicting a workspace management system 100 for implementing a workspace environment, according to an embodiment. It should be noted that the exemplary embodiment of system 100 may be varied in one or more aspects without departing from the spirit and scope of the teachings disclosed herein. Workspace management system 100 may comprise one or more of a hot-desking station 101, a workstation phone 104, a user communication device 102 and/or 103, a communication network 108, a calendar server 109, and a workspace management server 110. The workspace management system 100 may comprise a plurality of workspaces 105 each equipped with the hot-desking station 101 as well as other optional devices, such as a workstation phone 104. Workspaces 105 may comprise various workspace configurations known in the art such as hot-desking spaces, other dedicated workspaces within an open space concept, cubicles, co-working spaces, semi-private offices, private offices, or the like.

The workspace management system 100 can also integrate with a building control system 106. An exemplary building control system 106 is shown in FIG. 11. Building control system 106 can comprise a plurality of electronic devices adapted to change environmental setting within a building in which the workspace 105 is located, such as, lighting devices (including but not limited to lamps, ballasts, light emitting diode (LED) drivers), shading devices (including but not limited to motorized window treatments, dimmable windows), heating and air conditioning (HVAC) devices (214 including but not limited to thermostats, air conditioning units, heating units, filtration systems, fans, humidifiers), sensors (including but not limited to occupancy sensors, proximity sensors, sound sensors, microphones, temperature sensors), audiovisual (AV) devices (including but not limited to content sources, content sinks, video recorders, cameras, VCR, DVD/DVR, CD player, audio receivers, audio system devices, speakers, telephones, video phones, videoconference codecs (VTC), projectors, projector screens, touch panels, cable television box, television such as plasma, liquid crystal display (LCD), light-emitting diode (LED) flat panel, and cathode ray tube television), security devices (including but not limited to security cameras, monitors and door locks), appliances (including but not limited to refrigerators, ovens, blenders, microwaves), control devices (including but not limited to switches, relays, current limiting devices), industrial devices (including but not limited to motors, pumps, chillers, and air compressors). Other types of electronic devices are contemplated depending on building implementation. These various environmental devices may be managed by one or more control system processors.

Communication network 108 can incorporate one or more of the Internet, a wide area network (WAN), a local area network (LAN), a personal area network (PAN), a wireless network, a campus area network (CAN), a metropolitan area network (MAN), or the like. Communication network 108 may include a public switched telephone network (PSTN), a cable telephony network, an Internet Protocol (IP) telephony network, a wireless network, a hybrid Cable/PSTN network, a hybrid IP/PSTN network, a hybrid wireless/PSTN network, or any other suitable communication network or combination of communication networks. In addition, other network embodiments can be deployed with many variations in the number and type of devices, communication networks, communication protocols, system topologies, and myriad other details without departing from the spirit and scope of the present embodiments. Communication network 108 may include one or more gateway devices to interface with the communication network 108, which may include software and/or hardware components to manage traffic entering and exiting communication network 108 and conversion between the communication protocols used by various communication devices.

The calendar server 109 is configured for maintaining calendar data or scheduling data for spaces, such as workspaces 105 within a building. The calendar data or space scheduling data may include a schedule for a workspace 105 available for scheduling in a building. The schedule may indicate whether a workspace 105 is reserved or unreserved, the start time and end time of the space reservation, the name of the individual reserving the workspace, and other information pertaining to the workspace reservation. For example, the calendar server 109 may comprise calendar services including, without limitation, Microsoft Outlook® Exchange Calendar, Yahoo! Calendar®, Lotus Notes®, as well as others.

According to an embodiment, user communication device 102 may comprise a smartphone or a tablet comprising wireless charging capabilities adapted to receive power wirelessly from a wireless power charger as is known in the art. For such implementation, user communication device 102 may comprise a wireless power receiver capable of receiving power via induction charging by, for example, the implementation of the Qi wireless charging standard. Alternatively, user communication devices may comprise other portable electronic device known in the art that conventionally receive power via a wire, such as a smartphone or a tablet without a wireless power receiver, a portable computer 103 such as a laptop, or any other computer configured for communicating with a remove server, such as server 110, via a communication network 108 through a web-browser or other similar application. Each user communication device 102 or 103 may comprise a central processing unit (CPU), a user interface (e.g., display, keyboard, mouse, or the like), one of numerous forms of storage (e.g., solid-state memory (random access memory (RAM), read-only memory (ROM), and the like), magnetic memory, such as disc drives, tape storage, and the like, and/or optical memory, such as DVD), and a network interface, as is known in the art.

The user communication device 102 or 103 may be further adapted to communicate with the workspace management server 110 via communication network 108. According to one embodiment, the workspace management server, 110 may be accessible to the user communication device 102 via a unique Uniform Resource Locator (URL) and hostname. User communication devices 102 or 103 may access the services provided by the workspace management server 110 using a web browser, such as Internet Explorer, Microsoft Edge, Firefox, Google Chrome, Opera, Safari, or the like. According to another embodiment, user communication device 102 may comprise a proprietary native mobile app, or any other similar software application, configured to communicate with server 110 via the communication network 108.

Workspace management server 110 may be a dedicated, private server, employing standard security protocols. Although in other embodiments, the function of server 110 may be distributed across multiple computing systems and architectures. Multiple, redundant servers may be provided for additional backup and security. For example, server 110 may include separate web, app, or email servers. Server 110 can be further hosted via cloud computing or data center as is known in the art. Server 110 may comprise one or more network interfaces to provide connectivity with, among other things, calendar server 109, user communication devices 102 or 103, phone 104, and building control system 106. Server 110 may include one or more processing units configured for providing processing capability to execute an operating system, run various applications, and/or provide processing for one or more of the techniques described herein. Server 110 may further include any one of numerous forms of memory or databases for storing data. The database can be co-located with server 110, or it can be located remotely in various systems and locations.

Server 110 may comprise a plurality of software engines for providing the workspace management services discussed herein. Software engines may comprise a data structuring engine configured for structuring received data in order to establish various relationships, including but not limited to data regarding the hot-desking stations 101, data regarding users of communication devices 102, reservation information, data regarding the workspace 105 such as location data, what workspace equipment is present, and data on the electronic devices present at the workspace 105 and managed by the building control system 106, or the like. The software engines may also comprise a data retrieval engine for interfacing with other sources of data, such as the calendar server 109 and building control system 106. The software engines also comprise the analytics engine configured for analyzing data and a frontend engine configured for providing a visual display through which the end user interacts with the system. For example, the frontend engine may be configured for providing a web-based user interface on the user communication devices 102 or 103 through which the user can interact with the workspace management server 110. Particularly, the frontend engine may comprise a client-server software application which runs in a web-browser of a client computer, such as one or more user communication devices 102 or 103. To that end, the frontend engine may comprise a web application programming interface (API) which is exposed via the web. In another embodiment, the workspace management system 100 may comprise a proprietary native mobile app in communication with building management server 110 as discussed below.

Referring to FIGS. 2-4, there is shown an exemplary hot-desking station 101 according to one embodiment. Station 101 may be a free-standing product adapted to be placed on a surface area such as a desk. Alternatively, it may be permanently or removably attached to the desk, such as for example via desk mounting bracket or by being recessed into a cavity formed in the desk. Station 101 may comprise a wireless power charger 202, such as an induction charger, that comprises a wireless power transmitter. The wireless power charger 202 may transmit power via the implementation of the Qi wireless charging standard. Station 101 may comprise a charging area 205 upon which the user may place the user communication device 102 for charging, such as a circular plate-like surface area 205 shown in FIG. 2. Station 101 can be connected to a power supply to receive power via a power port 207. According to one embodiment, station 101 may be connected to an AC outlet via an external power supply or an AC adapter that converts AC to DC voltage. For example, power port 207 may comprise a barrel power connector known in the art. Alternatively, an AC adapter may be integrated within the station unit. According to another embodiment, station 101 may comprise a power over Ethernet (POE) port 207 adapted to receive power via Ethernet cabling. The power supply provides power to station 101 components, including the wireless power charger 202, and thereby to the user communication device 102 for charging.

Station 101 may further comprise a charging area 205 203 adapted to display data to the user. Display screen 203 may comprise an LCD screen, an LED screen, or other screen type known in the art. Display screen 203 may further comprise a touch screen capable of receiving user input, although adjacent buttons can also be utilized for user input. According to an embodiment, display screen 203 may be positioned over and centered within the charging area 205 as shown in FIG. 2. Alternatively, the display screen 203 may be positioned in proximity to the charging area as shown in FIG. 5. Station 101 further comprises a status bar 204 for status indication. Status bar 204 may comprise one or more light sources, such as LEDs, and a light diffuser for diffusing light. For example, status bar 204 may comprise an external ring as shown in FIG. 2 for circular form factor.

According to an embodiment, station 101 may further comprise a wired power charging port 206, such as an USB, USB-C, mini-USB, micro USB, or similar ports known in the art. User communication devices 102 or 103 without wireless power receiving capabilities may be connected to the wired power charging port 206 for receiving power from station 101. Also, a user may simultaneously use the wireless charger 202 to charge a smartphone and the wired power charging port 206 to charge a laptop or other devices. Station 101 may further comprise a processor, a memory, and a communication interface therein for communication with the workspace management server 110 over the communication network 108. According to an embodiment, station 101 may comprise a POE port adapted to receive both power and data. According to another embodiment, station 101 may comprise a wireless interface, such as Wi-Fi, Bluetooth, NFC, or similar interface for wireless communication with the user communication device 102 or 103.

Referring to FIGS. 6-8, there is shown a hot-desking station 600 according to another embodiment. Hot-desking station 600 may comprise a rectangular upright station body 610 connected to an adjustable stand 608 such that the body can swivel to different upright positions with respect to the stand 608. Hot-desking station 600 can comprise a seat 611 on which the user communication device 102 can rest. While hot-desking station 600 comprises a different form factor, it may comprise substantially the same components as station 101, including a wireless power charger 602 adapted to charge a user communication device 102 placed on the charging area 605, a wired power charging port 606, a display screen 603, a status bar 604, and a power supply port 607. According to an embodiment, the status bar 604 is located on top end of the station body 610 and is adapted to provide substantially a 360-degree view.

According to an embodiment, hot-desking station 101 (or 600) enabled a user to check-in and/or reserve workspace 105. According to one embodiment, the display screen 203 of the hot-desking station 101 may display a QR code, or a similar scannable code, capable of being scanned by a user communication device 102. For example, FIG. 9A shows a graphical user interface 900 that can be displayed on the display screen 203 of station 101 comprising a QR code 901. A user using the communication device 102 can scan the QR code 901 to identify the user in order to initiate the check-in or workspace reservation process. According to an embodiment, the QR code 901 can be dynamically generated by the workspace management server 110 and sent to station 101 for display. Unique QR codes 901 may be generated for each particular station 101 and for various circumstances as discussed below, for example dynamic QR codes not linked to reservations and dynamic QR codes linked to specific reservations.

The user interface 900 may further display the status 904 of the workspace 105 indicating whether the workspace 105 is free to use and for how long. Other information may also be displayed to the user, such as the date and time of day, weather information, battery life of a connected user communication device 102 or 103, or the like. FIG. 9B illustrates another screen of the graphic user interface 910. User interface 910 may display a schedule 903 of the hot-desking station 101 for workspace 105, which for example can be accessed by a user pressing on the “See Schedule” button 902 on user interface 900 in FIG. 9A. Although according to another embodiment, the QR code 901 and schedule 903 can be presented on the same screen. According to another embodiment, schedule 903 may only be accessible after the user checks into station 101. Schedule 903 may contain the reservation schedule of station 101 throughout the day. Schedule 903 can be stored on the calendar server 109 in association with an identification parameter of station 101 and transmitted to station 101 for display, on display screen 203. An identification parameter of station 101 may comprise a unique identification number assigned to station 101, a network address, such as an IP address or a MAC address, or the like. Reservation information may also be displayed for each reserved time period. For example, a user may click on a reserved time period 906 to review the reservation information, such as the start time, end time, identification information of the user who made the reservation, and the like. Although according to another embodiment, the identity of the users making the reservations can remain anonymous.

In a situation where the workspace 105 is unreserved, workspace management server 110 may generate a QR code not tied to a reservation and send it to the station 101 for display. According to an embodiment, that QR code can be displayed on station 101 until the station 101 is booked while it is still free for booking, or until the start of the next upcoming reserved period. During the period station 101 is available for booking, a user wishing to reserve the workspace 105 may scan the QR code 901 using the camera of the user communication device 102 to reserve the station 101 via the workspace management server 110. According to an embodiment, user communication device 102 may comprise native capability of recognizing QR codes 901. QR code 901 may be encoded with a URL address of a website, which upon scanning can direct the user communication device 102 to the website. The website may contain a form where the user can enter information, such as an identification number (e.g., employee ID) associated with the user, a user's first name, a user's last name, or the like. That information can be transmitted from the user communication device 102 to the workspace management server 110. The user may then use schedule 903 displayed on the display screen 203 of station 101 to select a period of time during which the station 101 is free and for which the user would like to reserve the workspace 105 associated with station 101; for example, by selecting a free time period 907 and/or by indicating the start time and end time of the reservation period. The selected reservation information is transmitted from station 101 to the workspace management server 110, which can associate the reservation information with the particular station 101 and the user information received from the website. The workspace management server 110 may change the status of station 101 as booked and send the reservation information to the calendar server 109. Station 101 may also change its status to booked, display the booked reservation in schedule 903, and change the color of its status light indicator 204 from free (e.g., green) to booked (e.g., red). The user can then place the user communication device 102 on charging area 205 for wireless charging or connect the user communication device 102 to port 206 for wired charging.

According to an embodiment, in workplace environment, the website form implementation can be used for guest users or employees utilizing personal user communication devices 102 and 103. According to another embodiment, the website can allow for authentication of employee users, such as by entering an employee login information (e.g., username or email and password) or via two-step authentication processes. Workspace management server 110 may in turn authenticate and identify the user as an employee. According to an embodiment, workspace management server, 110 can store information about a plurality of employee users, including their name, email address, title, department, or the like, as well as information concerning permissions and preferences associated with the user of station 101, as is further discussed below. Workspace management server 110 may send employee information to station 101 for display. For example, the user's name and photograph may be displayed on display 203 of station 101 during the time period station 101 is reserved by the user (e.g., in lieu of a permanent employee plaque). According to another embodiment, workspace 105 may contain another display in communication with station 101 and/or server 110 adapted to display user employee information to other employees; for example, such a display may be located outside of an office or a cubicle divider.

According to another embodiment, the user communication device 102 may comprise a proprietary reservation application or app adapted to interact with the workspace management server 110 to enable reservation of station 101. According to an embodiment, the reservation app may be standalone, or it may be an application framework running inside of another application, such as within a business communication platform (e.g., the Microsoft® Teams business communication platform) or the like. A user employee can download the reservation application and login via the reservation application using employee login credentials. To make a reservation of workspace 105 associated with station 101, the user may use a tool within the application to scan the QR code 901. The QR code 901 may for example contain a unique identification number that is associated with identification information of station 101 by workspace management server 110. The reservation application can communicate with the workspace management server 110 to transmit the data extracted from the QR code 901 along with the user identification information. The user can then proceed with reserving the hot-desking station 101 as discussed above.

According to another embodiment, workspace 105 may be limited to be used by a particular group of employees, such as a particular department within a company. A dynamic QR code generated by the server 110 may be associated with that department and particularly with the user employees of that department such that only the associated department employees are able to utilize the displayed QR code to make workspace reservation via station 101. All other employees and guests may be restricted from reserving the workspace—an error message may be displayed via the user communication device 102 and/or station 101, such as “you cannot reserve this workspace, it is reserved for the Legal Department”. According to another embodiment, a station 101 may be limited to be used by a single employee, or by particular employees during assigned periods of time. For example, a dynamic QR code may be generated that is associated only with a particular employee that can use the station 101. Or, one dynamic QR code may be generated for employee A for display on station 101 of workspace 105 on Mondays and Tuesdays, and another QR code may be generated for employee B for display on station 101 of workspace 105 on Thursdays and Wednesday.

According to an embodiment, in a workplace implementation, an employee user may reserve station 101 ahead of time. For example, the user may use a calendar software installed on a user communication device 102 or 103, or on a desktop computer, to create a reservation, for example using Microsoft® Outlook calendar software. Each workspace 105 may be displayed to the user as a selectable workspace object, which can be listed in a list of workspaces or displayed on a floor-map. Workspace objects can be identified by names, such as, “workspace 105 at 7 Volvo, second floor”. Each such object can be associated with a station 101 by server 110. Using the calendar software, the user can enter reservation information by selecting an available workspace object as well as a start time and an end time for the reservation. The reservation information, including user's identifying information, can be transmitted to the workspace management server 110 and displayed on the display screen 203 of the reserved station 101. According to an embodiment, server 110 may generate a unique reservation QR code associated with the reservation. During the period of the reservation and optionally just prior to the reservation, the reservation QR code may be displayed via the display screen 203. The reservation information can also be displayed on display screen 202 and the light indicator 204 may light up to indicate that the station 101 is reserved—such as via the color red. The employee user arriving at workspace 105 can scan the reservation QR code and get authenticated as discussed above to check-in. According to an embodiment, a user not making the reservation attempting to check-in during the reserved time period by scanning the QR code may be displayed a message via display screen 203 and/or user communication device 102 indicating that the workspace 105 is reserved by another user and that the check in is unsuccessful. Since the dynamic QR code is specific to the reservation, only the user who made the reservation can be able to use the QR code to check-in at station 101.

According to another embodiment, when making the reservation, the workspace management server 110 may also issue specific reservation credentials, such as a reservation pin. Upon scanning of the QR code via the user communication device 102 (for example without using a proprietary reservation application), the user may be presented with a form via a website asking the user to enter the reservation credential to verify the user and check-in.

According to another embodiment, instead of using a QR code, a user may check-in and be identified at station 101 using other technologies known in the art, such via Bluetooth, NFC, RFID, or the like. According to another embodiment, the wireless power receiver of the user communication device 102 may transmit data to the wireless power transmitter of station 101 via analog pulses, digital pulses, optical data transmission, via electromagnetic induction, or the like. In either of the above discussed implementations, the user communication device 102/103 may transmit data to station 101, for example containing user identification information, reservation information, or similar data to station 101 to enable user identification for workspace booking or check-in.

The station 101 of the present embodiments can further be used in a remote and/or from home environment. It can be used by employee users to check-in and check-out to work from home. The time the user checks-in and checks-out can be transmitted from station 101 to the workspace management server 110 and be used for employee time-stamp purposes. To communicate with server 110, station 101 may connect to the Internet via the user's local area network, such as via Ethernet or Wi-Fi. The user may be maintained as “checked-in” only when station 101 detects that a user communication device 102 is present on the wireless charging area 205 via the wireless power transmitter of station 101 or when a user communication device 102 is connected to the wired power port 206. In addition, the QR code of station 101 located on user employee's desk can dynamically and periodically change (e.g., daily) requiring the employee to daily scan the QR code to check-in for a workday.

The present embodiments also enable monitoring of the number of users and the identity of the users present in a building, floor, or an open floor workspace at any particular time of the day. This allows management to understand where its employees are located in an agile workspace environment. This enables, for example, identification of employee location within buildings during emergency situations for evacuation purposes.

Since station 101 is integrated with the workspace management server 110, and can further integrate with a building control system 106, and/or other systems known in the art, the act of checking in or reserving the workspace 105 via station 101 may trigger one or a plurality of events. Such events may be trigged for all users checked in at workspace 105 regardless of the user identity, or the events may vary depending on the identity of the checked-in user based on user permissions or preferences. User permissions may be assigned permissions stored by the workspace management server 110 in association with user identification. Permissions may vary based on the user department, title, or the like. User preferences may be set by the user, for example using the reservation application discussed above, or another application. Workspace 105 may be equipped with one or more electronic devices that may activate upon proper authentication of the user. Workspace management server 110 may further maintain workspace information associated with each workspace 105, including but not limited to the location of the workspace 105 within a building, the department (or team) to which the workspace 105 belongs to (if any), access levels to the workspace 105, and available resources such as the equipment present at each workspace 105, identification of controllable environmental conditions at the workspace 105, or the like.

According to an embodiment, a triggered event can comprise the unlocking of and switching on power provided to one or more power supplies, such as receptacles, located at the workspace 105 and which can be controlled by a control processor of a building control system 106. Workspace 105 may be equipped with a switchable power distribution unit (PDU) that is controlled by the control system 106 based on signals received from the workspace management server 110. The switchable PDU may control one or more wall receptacles. According to another embodiment, workspace 105 may contain a desk equipped with a cable management system, such as FlipTop cable management system available from Crestron Electronics, Inc., recessed into the desk and containing power and network connections. The cable management system can be connected to the switchable PDU for power control. Another action may unlock network access, either wired or wireless. Station 101 equipped with Bluetooth may for example transmit Wi-Fi access token to the user communication device 102. For wired connections, checking-in may unlock network connection ports available at the workspace 105, for example by the cable management system. Network connection may also be provided based on user permissions. For example, guest users may only be allowed limited access to a guest network, while properly authentication employees may be allowed full access to the corporate network. Once reservation has expired, or the user checks-out, power and network availability may be turned off.

Workspace 105 may further be equipped with a phone 104 which may be activated by the workspace management server 110 upon user check-in at the hot-desking station 101. According to an embodiment, phone 104 may run a communication application (such as Microsoft® Teams). Proper authentication of the user may cause the user to be automatically logged into the user account via the communication application ran on the phone 104. Particularly, workspace management server 110 may transmit user login credentials to phone 104 associated with hot-desking station 101. As such, user can receive incoming calls directly at the checked-in workspace 105. After the completion of the reserved time period, the user may be logged out of the phone 104. Or the user may use station 101 to check out earlier.

According to another embodiment, check-in can also allow and trigger an automatic pairing of the user's devices with the equipment at the hot-desking station 101 based on user's permissions stored by the workspace management server 110. For example, the user can bring and utilize her own Bluetooth headset that can be automatically paired with the phone 104 by automatically triggering a Bluetooth handshake. According to an embodiment, workspace management server 110 may maintain pairing information for the user's headset. That information may be passed from the server 110 to the phone 104 upon successful authentication. The phone 104 may then automatically pair to the headset. Pairing information exchanged between the devices may be maintained by the phone 104 and headset while the user is checked-in at the station 101. However, when the reservation is terminated, or the user checks-out, the headset is unpaired from the phone 104 and pairing information is erased from the phone 104 and the headset.

According to a further embodiment, hot-desking station 101 may be integrated with the phone 104. FIG. 10 illustrates an embodiment of phone 1000. Phone 1000 may contain a display screen 1003 adapted to display the dynamic QR code to allow the user to check-in or reserve a workspace 105 via the phone 1000 in substantially the same manner as discussed above. Phone 1000 may also be equipped with a wireless power charger 1002 containing a charging area 1005 to provide power to the user communication device 102 as discussed above. Wired power charging port 1006 may also be provided for charging a user communication device 102 or 103. Phone 1000 may also contain a status light indicator 1004 as discussed above.

According to further embodiments, checking-in at or reserving a hot-desking station 101 (600 or 1000) may trigger the building control system 106 to change environmental settings of the workspace 105. Using the reservation application, or another application or a web browser, a user may input personal preferences, including but not limited to lighting conditions, temperature settings, shading settings, volume settings, or the like. These personal preferences may be stored at the workspace management server 110 in association with user identification information. Upon checking in, the workspace management server 110 may communicate these settings or preferences to the building control system 106. Building control system 106 may determine which control or controllable electronic devices are associated with the reserved workspace 105 and change the settings of such devices based on the received user preferences. Accordingly, the environmental settings of the workspace 105 may be adjusted based on preferred working environment of the user.

A method for personalizing operation of a building control system of a workspace management system, according to a different embodiment of the present disclosure may include receiving, over a communication network, from the workspace management server a first message comprising an identification of the workspace to be displayed as a QR code on the first graphical display device of the workstation phone. In an embodiment, a user communication device, a hot-desking station, and a workstation phone having a first graphical display device are included. The workstation phone may be communicatively coupled to a workspace management server.

In some embodiments, the receiving may include a request to personalize the workspace, according to the predetermined personalization settings. The user communication device may comprise a camera having a first interface for a first communication channel, a second interface for a second communication channel, where the first message being received by the first interface and after receiving the first message, transmitting, by the user communication device via the second interface, a second message comprising an identity associated with the communication device, an identification of the workspace, and a predetermined personalization setting. Instructions to provide access to the building control system and a second graphical display that may be physically separate from the workstation phone and may be not in direct communication with the communication device. In some embodiments, the first interface may comprise an interface to a near-field communications channel configured to operate without a prior association between the user communication device and the workstation phone. In some embodiments, transmitting the second message may include performing one or more additional steps.

In some embodiments, the method may include receiving, by a workstation phone via a user interface, a command to initiate personalization of the workstation phone. The method may include, in response to receiving the command to initiate personalization, generating and transmitting, by the workstation phone, to a user communication device, a first message including an identification of the workspace.

In some embodiments, the method may include, after transmitting the first message, receiving by the workstation phone via the second interface, a second message. The method may include personalizing, by the workstation phone, its operation based on the predetermined personalization information by modifying a graphical user interface presented the second graphical display device to provide access to a building control system.

In some embodiments, the workstation phone comprises a first interface including an interface to a near field communications channel configured to operate without a prior association between the user communication device and the computer system for a first communication channel and a second interface for a second communication channel, the first message being transmitted by the first interface. Wherein after transmitting the first message, receiving by the workstation phone via the second interface, a second message comprising: predetermined personalization information related to personalizing the workstation phone. A portion of the predetermined personalization information may be associated with an identity of the user communication device. The second graphical display device may be physically separate from the workstation phone and may be not in direct communication with the user communication device. In some embodiments, the second message may be received from a workspace management server via a communication network channel coupled with the second interface.

In some embodiments, the method may include receiving, by a user communication device, from the workspace management server a first message including displayed QR code as an identification of the workspace. The method may include, after receiving the first message, transmitting, by the user communication device via the second interface the workspace management server, a second message comprising predetermined personalization information related to personalizing the workstation phone, wherein a portion of the predetermined personalization information is associated with an identity of the user communication device; and personalizing, by the workstation phone, its operation based on the predetermined personalization information by modifying a graphical user interface presented the said second graphical display device to provide access to a building control system, wherein the second graphical display device is physically separate from the workstation phone and is not in direct communication with the user communication device.

In some embodiments, the method may include receiving, by the user communication device, from the workspace management server, predetermined personalization information related to personalizing the operation of the hot-desking station. The method may include, based on the predetermined personalization information, transmitting, by the user communication device, personalization settings relating to personalizing the operation of the hot-desking station.

In some embodiments, a user computing device communicatively coupled to a graphical display device. The user communication device may comprise an imaging sensor including a first interface for a short range communication channel and a second interface for a network communication channel, the first message being received by the first interface.

The predetermined personalization information may be based, at least in part, on the identity associated with the user communication device and the identification of the workspace. The personalization settings may include instructions to modify a graphical user interface presented by the graphical display device and provide access to a building control system. The graphical display device may be physically separate from the computer system and may be not in direct communication with the communication device.

In some embodiments, the workspace management system may include a user communication device and a workstation phone communicatively coupled to a building control system. The user communication device may include a third interface for the first communication channel and a fourth interface for the second communication channel, a second processor in communication with the second memory device, and an identification of the workspace. The user communication device may also include a second memory device, storing second executable instructions.

In some embodiments, the second processor, when executing the second executable instructions, receives from the workstation phone, a first message, via the third interface. After receiving the first message, transmits, a second message to a workspace management server, via the fourth interface. The workstation phone may include a first interface for a first communication channel and a second interface for a second communication channel and a first processor in communication with the first memory device. The workstation phone may also include a first memory device, storing first executable instructions.

In some embodiments, the second message may include an identity associated with the communication device. The second message may also include a request to personalize according to predetermined personalization information, the operation of devices located at the hot-desking station. The identification of the workspace. The first processor, when executing the first executable instructions, receives, via the second interface, personalization instructions to personalize the operation of the building control system based on the predetermined personalization information. Personalizes the operation of any devices controlled by the building control system based on the predetermined personalization information.

In some embodiments, when executing the first executable instructions, the first processor receives the personalization instructions, via the second interface, from the workspace management server. In some embodiments, when executing the second executable instructions, the second processor receives, via the fourth interface, at least a portion of the predetermined personalization information from the workspace management server. Transmits the personalization instructions, via the fourth interface, to the building control system.

In some embodiments, the workspace management system may include a building control system, a workspace management server, a calendar server, a user communication device, and a hot-desking station. The building control system may include a plurality of electronic devices within a workspace. The workspace management server may include data storage and a sixth communication interface configured to communication with a communication network.

In some embodiments, the user communication device may include a camera configured to capture a QR Code. The user communication device may also include a first communication interface configured to transmit an unencrypted identification of the workspace represented by the QR Code, a request to personalize a workspace according to a predetermined personalization setting, and a request a network encryption key. The user communication device may also include a second communication interface that may be configured to be unlocked by the network encryption key, the second communication interface configured to further communicate predetermined personalization information with the building control system after receipt of the network encryption key.

In some embodiments, the hot-desking station may include a wired power charging port, a wireless power charger, a display screen positioned over and centered within the charging area for displaying the QR Code, a third communication interface for communication with the workspace management server and building control system, a fourth communication interface for unencrypted communication with the user communication device, a fifth communication interface for encrypted communication with the user communication device, and a status bar for status indication. The wireless power charger may include a charging area.

While the present embodiments were discussed with reference to a workspace, station 101 or integrated phone station 1000 may be implemented in other types of environments, including but not limited to residential spaces, hotels, education facilities, or the like, for other uses.

For example, in a hotel environment, hot-desking stations 101 may be provided in different locations throughout the hotel giving a user who booked a hotel room power access, network access, and control of preferred environmental settings, or the like. Station 101 and phone 104 (or integrated station 1000) may further be located within the hotel room to provide phone services, network access, power access, and control of preferred environmental settings within the hotel room. Checking-in may allow different guest permissions—for example, different phone communications levels based on the communication services purchased by the hotel guest, including making calls only within the hotel, making outside calls, or making distance calls.

Station 101 may also be used in residential applications, apart from working from home environments. For example, station 600 (FIG. 6) may be used at the user's bedside to provide phone charging as well as to display information via screen 603. The unit may be freestanding, and the user may lean the user communication device 102 against the charging surface 605 of the wireless power charger 602. The display 603 may display the date and the time of day as well as the user's schedule. Station 101 may integrate with a residential building control system 106 to transmit and receive commands, such as with Crestron Home control system for home automation. According to an embodiment, station 600 can detect that a phone 102 is present on the charger and change environmental setting of the room based on the presence of the phone 102. According to another embodiment, station 600 can identify whether a building control application is running on the phone 102 or identify the user identity, for example via Bluetooth or NFC or similar pairing, and trigger the residential control system to change environmental settings based on the user's preferences. For example, if located at bedside, where a phone is typically placed before going to sleep, the environmental settings can change to evening preferences, such as dimming of the lights, turning on relaxing music, turning down the heat, or the like.

### INDUSTRIAL APPLICABILITY

To solve the aforementioned problems, the aspects of the embodiments are directed towards a workspace management system, and more specifically to systems, methods, and modes for providing a hot-desking station. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described as being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus, the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

In addition, the above disclosed methods are not meant to limit the aspects of the embodiments, or to suggest that the aspects of the embodiments should be implemented following the aforementioned methods. The purpose of the aforementioned methods is to facilitate the understanding of one or more aspects of the embodiments and to provide the reader with one or many possible implementations of the processed discussed herein. It should be understood by one of ordinary skill in the art that the steps of the aforementioned methods may be performed in a different order and that some steps may be eliminated or substituted.

### ALTERNATE EMBODIMENTS

Alternate embodiments may be devised without departing from the spirit or the scope of the different aspects of the embodiments.

What is claimed is:

1. A method for personalizing operation of a building control system of a workspace management system comprising:
a user communication device;
a hot-desking station; and
a workstation phone having a first graphical display device, wherein said workstation phone is communicatively coupled to a workspace management server, the method comprising:
receiving, over a communication network, from the workspace management server a first message comprising an identification of the workspace to be displayed as a QR code on said first graphical display device of said workstation phone, wherein the user communication device comprises:
a camera having a first interface for a first communication channel; and
a second interface for a second communication channel, the first message being received by the first interface and after receiving the first message, transmitting, by the user communication device via the second interface, a second message comprising:
an identity associated with the communication device;
an identification of the workspace;
a predetermined personalization setting; and
a request to personalize said workspace, according to the predetermined personalization settings, the request comprising:
instructions to provide access to said building control system and a second graphical display that is physically separate from the workstation phone and is not in direct communication with the communication device.

2. The method of claim 1, wherein the first interface comprises an interface to a near-field communications channel configured to operate without prior association between the user communication device and the workstation phone.

3. The method of claim 1, wherein transmitting the second message further comprises:
transmitting the second message to said workspace management server via a network communication channel coupled with the second interface.

4. A method for personalizing operation of a hot-desking station communicatively coupled to a second graphical display device in a workspace, the method comprising:
receiving, by a workstation phone via a user interface, a command to initiate personalization of the workstation phone;
in response to receiving the command to initiate personalization, generating and transmitting, by the workstation phone, to a user communication device, a first message including an identification of the workspace, wherein the workstation phone comprises a first interface including an interface to a near field communications channel configured to operate without prior association between the user communication device and the computer system for a first communication channel and a second interface for a second communication channel, the first message being transmitted by the first interface;
after transmitting the first message, receiving by the workstation phone via the second interface, a second message comprising:
predetermined personalization information related to personalizing the workstation phone, wherein a portion of the predetermined personalization information is associated with an identity of the user communication device; and
personalizing, by the workstation phone, its operation based on the predetermined personalization information by modifying a graphical user interface presented at the said second graphical display device to provide access to a building control system, wherein the second graphical display device is physically separate from the workstation phone and is not in direct communication with the user communication device.

5. The method of claim 4, wherein the second message is received from a workspace management server via a communication network channel coupled with the second interface.

6. A method for personalizing operation of a hot-desking station in a workspace comprising:
a user computing device communicatively coupled to a graphical display device, the method comprising:
receiving, by a user communication device, from the workspace management server a first message including displayed QR code as an identification of the workspace, wherein the user communication device comprises an imaging sensor including a first interface for a short range communication channel and a second interface for a network communication channel, the first message being received by the first interface;
after receiving the first message, transmitting, by the user communication device via the second interface the workspace management server, a second message comprising:
an identity associated with the communication device; and
the identification of the workspace;
receiving, by the user communication device, from the workspace management server, predetermined personalization information related to personalizing the operation of the hot-desking station, wherein the predetermined personalization information is based, at least in part, on the identity associated with the user communication device and the identification of the workspace; and
based on the predetermined personalization information, transmitting, by the user communication device, personalization settings relating to personalizing the operation of the hot-desking station, wherein the personalization settings include instructions to modify a graphical user interface presented by the graphical display device and provide access to a building control system, wherein the graphical display device is physically separate from the computer system and is not in direct communication with the communication device.

7. A workspace management system for personalizing devices located at a hot-desking station, the system comprising:
a workstation phone communicatively coupled to a building control system, the workstation phone comprising:
a first interface for a first communication channel and a second interface for a second communication channel;
a first memory device, storing first executable instructions; and
a first processor in communication with the first memory device;
a user communication device, the user communication device comprising:
a third interface for the first communication channel and a fourth interface for the second communication channel;
a second memory device, storing second executable instructions; and
a second processor in communication with the second memory device; wherein the second processor, when executing the second executable instructions:
receives, from the workstation phone, a first message, via the third interface, comprising an identification of the workspace; and
after receiving the first message, transmits, a second message to a workspace management server, via the fourth interface, the second message comprising:
an identity associated with the communication device;
the identification of the workspace; and
a request to personalize according to predetermined personalization information, the operation of devices located at the hot-desking station; and wherein the first processor, when executing the first executable instructions:
receives, via the second interface, personalization instructions to personalize the operation of the building control system based on the predetermined personalization information; and
personalizes the operation of any devices controlled by the building control system based on the predetermined personalization information.

8. The system of claim 7, wherein when executing the first executable instructions, the first processor receives the personalization instructions, via the second interface, from the workspace management server.

9. The system of claim 7, wherein when executing the second executable instructions, the second processor:
receives, via the fourth interface, at least a portion of the predetermined personalization information from the workspace management server; and
transmits the personalization instructions, via the fourth interface, to the building control system.

10. A workspace management system comprising:
a building control system having a plurality of electronic devices within a workspace;
a workspace management server comprising:
data storage; and
a sixth communication interface configured to communication with a communication network;
a calendar server;
a user communication device comprising:
a camera configured to capture a two-dimensional bar code; and
a first communication interface configured to transmit an unencrypted identification of the workspace represented by the two-dimensional bar code, a request to personalize a workspace according to a predetermined personalization setting, and a request a network encryption key; and
a second communication interface that is configured to be unlocked by said network encryption key, the second communication interface configured to further communicate predetermined personalization information with said building control system after receipt of said network encryption key; and
a hot-desking station comprising:
a wired power charging port and a wireless power charger having a charging area;
a display screen positioned over and centered within said charging area for displaying said two-dimensional bar code;
a third communication interface for communication with said workspace management server and building control system;
a fourth communication interface for unencrypted communication with said user communication device;
a fifth communication interface for encrypted communication with said user communication device; and
a status bar for status indication.

11. The system of claim 10, wherein said two-dimensional bar code is a QR Code.
